(19) United States
(12) Patent Application Publication
(10) Pub. No.: US 2025/0384813 A1
(43) Pub. Date: Dec. 18, 2025

(54) DISPLAY DEVICE AND ELECTRONIC APPARATUS INCLUDING THE SAME

(71) Applicant: Samsung Display Co., Ltd., Yongin-si (KR)

(72) Inventor: JINWOO NOH, Yongin-si (KR)

(21) Appl. No.: 19/212,632

(22) Filed: May 19, 2025

(30) Foreign Application Priority Data
Jun. 13, 2024 (KR) 10-2024-0076699

(51) Int. Cl. G09G 3/20

(52) U.S. Cl. CPC G09G 3/2096; G09G 2310/0275; G09G 2354/00; G09G 2380/02

(57) ABSTRACT

A display device includes: a display panel including a first display area configured to display a virtual keyboard including a plurality of virtual keys and a second display area adjacent to the first display area; a data driver configured to provide a data voltage to the display panel; and a controller configured to provide a data signal to the data driver, wherein the controller configured to generate the data signal to reduce or enlarge the virtual keyboard with respect to a center of the virtual keyboard within a selected range at a selected time interval.

### CROSS-REFERENCE TO RELATED APPLICATION

The present application claims priority to and the benefit of Korean Patent Application No. 10-2024-0076699, filed on Jun. 13, 2024, in the Korean Intellectual Property Office, the entire disclosure of which is incorporated herein by reference.

### BACKGROUND

### 1. Field

Aspects of some embodiments relate to a display device. For example, aspects of some embodiments relate to a flexible display device, a method of driving the flexible display device, and an electronic apparatus including the flexible display device.

### 2. Description of the Related Art

A display device may include a display panel and a panel driver. The display panel may include a plurality of gate lines, a plurality of data lines, and a plurality of pixels. The panel driver may include a gate driver that provides gate signals to the gate lines, a data driver that provides data voltages to the data lines, and a controller that controls the gate driver and the data driver.

Recently, a foldable display device that can be folded by maximizing folding characteristics of a foldable display panel has been developed. The foldable display panel may be folded along a folding line without damaging the display device, and accordingly, the foldable display panel may include a plurality of display areas separated by the folding line.

In order to input characters, etc., a virtual keyboard may be displayed in a first display area among the display areas of the foldable display panel, and characters, etc. may be input using the virtual keyboard. When the virtual keyboard is used, characters, etc. may be input without a separate keyboard. Further, the virtual keyboard may be displayed in the first display area when input of characters, etc. is required, and images may be displayed in the first display area when the input of characters, etc. is not required.

When still images, such as the virtual keyboard, are displayed on the display panel for a long period of time, an afterimage caused by the still images may occur. To prevent the afterimage caused by the still images, a pixel shift such as a boundary shift in which the still images move along an edge of the display area, an internal shift in which a part of the still images are reduced and another part of the still images are enlarged, etc. may be used.

The above information disclosed in this Background section is only for enhancement of understanding of the background and therefore the information discussed in this Background section does not necessarily constitute prior art.

### SUMMARY

Aspects of some embodiments of the present disclosure include a display device which may be capable of preventing or reducing an afterimage by a virtual keyboard and an electronic apparatus including the display device.

Aspects of some embodiments of the present disclosure include a method of driving a display device for preventing or reducing an afterimage by a virtual keyboard.

A display device according to some embodiments may include a display panel including a first display area which displays a virtual keyboard including a plurality of virtual keys and a second display area adjacent to the first display area, a data driver which provides a data voltage to the display panel, and a controller which provides a data signal to the data driver. According to some embodiments, the controller may generate the data signal to reduce or enlarge the virtual keyboard with respect to a center of the virtual keyboard within a selected range at a selected time interval.

According to some embodiments, the virtual keyboard may be reduced or enlarged while maintaining a length ratio of a long side of the virtual keyboard to a short side of the virtual keyboard.

According to some embodiments, the short side of the virtual keyboard may be reduced or enlarged by one pixel at the selected time interval.

According to some embodiments, the selected range may be from 99% to 100% of an initial size of the virtual keyboard.

According to some embodiments, the selected time interval may be from 20 seconds to 40 seconds.

According to some embodiments, a first data signal may correspond to the virtual keyboard at a first time point, and a second data signal may corresponds to the virtual keyboard at a second time point after the selected time interval from the first time point. According to some embodiments, the controller may generate a plurality of data signals by mixing the first data signal and the second data signal over a plurality of frames between the first time point and the second time point.

According to some embodiments, a mixing ratio of the first data signal may decrease and a mixing ratio of the second data signal may increase during the plurality of frames.

According to some embodiments, the controller may compensate a plurality of touch areas for the plurality of virtual keys in response to reduction or enlargement of the virtual keyboard.

According to some embodiments, the display panel may be foldable along a folding line, the first display area may be located on a first side of the folding line, and the second display area may be located on a second side of the folding line.

A display device according to some embodiments may include a display panel including a first display area which displays a virtual keyboard including a plurality of virtual keys and a second display area adjacent to the first display area, a data driver which provides a data voltage to the display panel, and a controller which provides a data signal to the data driver. According to some embodiments, the controller may generate the data signal to reduce or enlarge each of the plurality of virtual keys with respect to a center of each of the plurality of virtual keys within a selected range at a selected time interval.

According to some embodiments, each of the plurality of virtual keys may be reduced or enlarged while maintaining a length ratio of a long side of each of the plurality of virtual keys to a short side of each of the plurality of virtual keys.

According to some embodiments, the short side of each of the plurality of virtual keys may be reduced or enlarged by one pixel at the selected time interval.

According to some embodiments, the selected range may be from 99% to 100% of an initial size of each of the plurality of virtual keys.

According to some embodiments, the selected time interval may be from 20 seconds to 40 seconds.

According to some embodiments, a first data signal may correspond to the virtual keyboard at a first time point, and a second data signal may correspond to the virtual keyboard at a second time point after the selected time interval from the first time point. According to some embodiments, the controller may generate a plurality of data signals by mixing the first data signal and the second data signal over a plurality of frames between the first time point and the second time point.

According to some embodiments, a mixing ratio of the first data signal may decrease and a mixing ratio of the second data signal may increase during the plurality of frames.

In an electronic apparatus including a display device which displays images and a processor which provides input image data to the display device according to some embodiments, the display device may include a display panel including a first display area which displays a virtual keyboard including a plurality of virtual keys and a second display area adjacent to the first display area, a data driver which provides a data voltage to the display panel, and a controller which generates a data signal based on the input image data and provides the data signal to the data driver. The controller may generate the data signal to reduce or enlarge the virtual keyboard with respect to a center of the virtual keyboard within a selected range at a selected time interval.

According to some embodiments, the virtual keyboard may be reduced or enlarged while maintaining a length ratio of a long side of the virtual keyboard to a short side of the virtual keyboard.

According to some embodiments, the short side of the virtual keyboard may be reduced or enlarged by one pixel at the selected time interval.

According to some embodiments, the selected range may be from 99% to 100% of an initial size of the virtual keyboard.

In the display device, the method of driving the display device, and the electronic apparatus according to some embodiments, the virtual keyboard/virtual key is reduced or enlarged with respect to the center of the virtual keyboard/virtual key within the selected range at the selected time interval, so that the afterimage caused by the virtual keyboard may decrease. Further, in the process of reducing or enlarging the virtual keyboard, the virtual keyboard is symmetric and the sizes of the virtual keys are uniform, so that display quality of the virtual keyboard may be relatively improved.

### BRIEF DESCRIPTION OF THE DRAWINGS

Illustrative, non-limiting embodiments will be more clearly understood from the following detailed description taken in conjunction with the accompanying drawings.

FIG. 1 is a perspective view showing a display device according to some embodiments.

FIG. 2 is a plan diagram showing the display device of FIG. 1.

FIG. 3 is a block diagram showing the display device of FIG. 1.

FIG. 4 is a view showing an example of a display panel in a keyboard mode operation.

FIG. 5 is a view showing an example of reduction and enlargement of a virtual keyboard.

FIG. 6 is a view showing an example of micro shift of the virtual keyboard.

FIG. 7 is a view showing an example of reduction and enlargement of virtual keys of the virtual keyboard.

FIGS. 8 and 9 are flowcharts showing a method of driving a display device according to some embodiments.

FIG. 10 is a block diagram showing an electronic apparatus according to some embodiments.

FIG. 11 is a view showing an example in which the electronic apparatus of FIG. 10 is implemented as a foldable computer.

### DETAILED DESCRIPTION

Hereinafter, a display device, a method of driving a display device, and an electronic apparatus according to some embodiments of the present disclosure will be described in more detail with reference to the accompanying drawings. The same or similar reference numerals will be used for the same elements in the accompanying drawings.

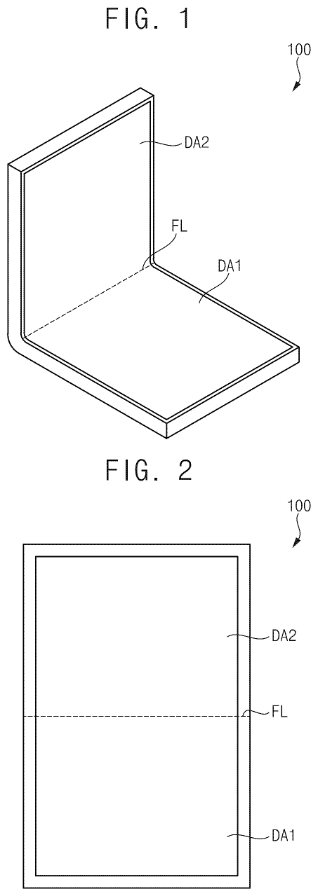

FIG. 1 is a perspective view showing a display device 100 according to some embodiments. FIG. 2 is a plan diagram showing the display device 100 of FIG. 1.

Referring to FIGS. 1 and 2, a display device 100 may be a foldable display device. The display device 100 may include a foldable display panel.

The display panel may be foldable along a folding line FL. The display panel may include a first display area DA1 and a second display area DA2. The first display area DA1 may be located on a first side of the folding line FL, and the second display area DA2 may be located on a second side of the folding line FL opposite to the first side.

In a first mode, the first display area DA1 and the second display area DA2 may display one continuous image (e.g., spread across the first display area DA1 and the second display area DA2, or displaying a first portion at the first display area DA1 and a second portion at the second display area DA2). For example, an image displayed by the first display area DA1 may be different from an image displayed by the second display area DA2 (but collectively, the image displayed at the first display area DA1 and the second display area DA2 may form a single continuous image). The first mode may be an unfolding mode in which the display panel is unfolded, as illustrated in FIG. 2. The first mode may be a normal mode.

In a second mode, the first display area DA1 and the second display area DA2 may display different images with respect to the folding line FL. For example, a second image displayed by the second display area DA2 may be a main image for a user to work on a document, and a first image displayed by the first display area DA1 may be an auxiliary image to assist the second image. The second mode may be a folding mode in which the display panel is folded, as illustrated in FIG. 1. The second mode may be a keyboard mode. When the keyboard mode is operated, the first image may be a virtual keyboard including virtual keys.

According to some embodiments, the first mode and the second mode may be determined according to unfolded/folded state of the display panel. According to some embodiments, the first mode and the second mode may be determined according to user settings regardless of the unfolded/folded state of the display panel.

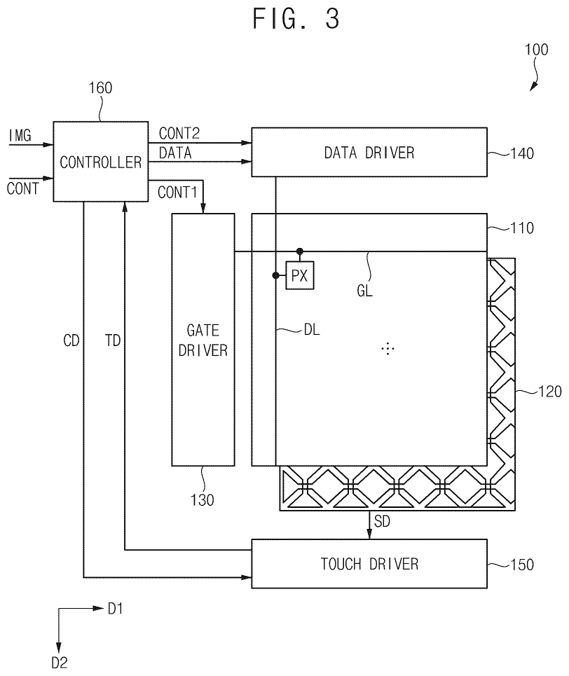

FIG. 3 is a block diagram showing the display device 100 of FIG. 1.

Referring to FIGS. 1 to 3, the display device 100 may include a display panel 110, a touch panel 120, and a panel driver. The panel driver may include a gate driver 130, a data driver 140, a touch driver 150, and a controller 160.

The display panel 110 may include a plurality of gate lines GL, a plurality of data lines DL, and a plurality of pixels PX. The gate lines GL may extend in a first direction D1, and the data lines DL may extend in a second direction D2 intersecting the first direction D1. The pixels PX may be connected to the gate lines GL and the data lines DL. Although FIG. 3 illustrates a single pixel PX, a single data line DL, and a single gate line GL, as a person having ordinary skill in the art would appreciate, the display panel 110 may include any suitable number of pixels PX, data lines DL, and gate lines GL according to the design and size of the display panel 110.

According to some embodiments, the display panel 110 may include the first display area DA1 arranged adjacent to a first end of the display panel 110 and the second display area DA2 arranged adjacent to a second end of the display panel 110 opposite to the first end. The first display area DA1 and the second display area DA2 may be connected to each other. The first display area DA1 and the second display area DA2 may be distinguished based on the folding line FL along which the display panel 110 is folded.

The touch panel 120 may be a capacitance-type touch panel that senses a capacitance change due to a touch of a conductive object (e.g., a finger, a stylus pen, etc.). The touch panel 120 may include a plurality of touch electrodes. For example, the touch panel 120 may include a plurality of first touch electrodes extending in the first direction D1 and a plurality of second touch electrodes extending in the second direction D2. According to some embodiments, the first touch electrodes and the second touch electrodes may be formed on the same layer. In this case, each of the first touch electrodes and the second touch electrodes may have a structure in which diamond-shaped polygons are continuously connected. According to some embodiments, the first touch electrodes and the second touch electrodes may be formed on different layers. In this case, each of the first touch electrodes and the second touch electrodes may have a structure in a straight line shape.

Further, according to some embodiments, the touch panel 120 may be an add-on type touch panel attached on the display panel 110 or an embedded type touch panel formed within the display panel 110. For example, the touch panel 120 may be an on-cell embedded type touch panel or an in-cell embedded type touch panel.

The touch panel 120 may receive a touch input using touch electrodes. The touch driver 150 may receive sensing data SD including the touch input.

The gate driver 130 may generate gate signals in response to a first control signal CONT1. The first control signal CONT1 may include a vertical start signal, a gate clock signal, etc. The gate driver 130 may output the gate signals to the gate lines GL.

The data driver 140 may generate a data voltage in response to a second control signal CONT2 and a data signal DATA. The second control signal CONT2 may include a horizontal start signal, a load signal, etc. The data driver 140 may convert the digital data signal DATA into the analog data voltage. The data driver 140 may output the data voltage to the data line DL.

The touch driver 150 may receive the sensing data SD from the touch panel 120. The touch driver 150 may generate touch data TD corresponding to the touch input based on the sensing data SD. For example, when the keyboard mode is operated, the touch driver 150 may generate the touch data TD for input key values based on the touch input. The touch driver 150 may provide the touch data TD to the controller 160.

The controller 160 may receive input image data IMG and an input control signal CONT from an external device. For example, the input image data IMG may include red image data, green image data, and blue image data. The input control signal CONT may include a master clock signal, a vertical synchronization signal, a horizontal synchronization signal, a data enable signal, etc. The controller 160 may receive the touch data TD from the touch driver 150. For example, the touch data TD may include a touch input signal, an input key value, etc.

The controller 160 may generate the first control signal CONT1 based on the input control signal CONT. The controller 160 may generate the second control signal CONT2 based on the input control signal CONT. The controller 160 may generate the data signal DATA based on the input image data IMG and the touch data TD.

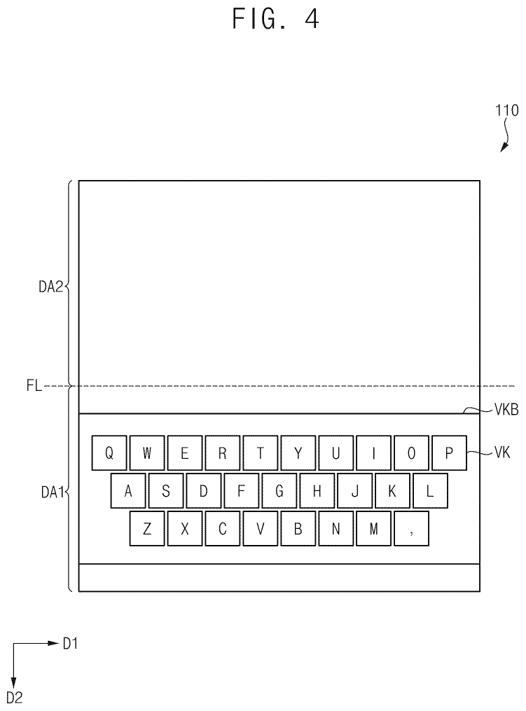

FIG. 4 is a view showing an example of the display panel 110 in a keyboard mode operation.

Referring to FIGS. 3 and 4, in the folding mode, the display panel 110 may display the second image, which is the main image, on the second display area DA2, and the first image, which is the auxiliary image, on the first display area DA1. For example, when the keyboard mode is operated, the second image may be displayed on the second display area DA2, and the virtual keyboard VKB including the plurality of virtual keys VK may be displayed on the first display area DA1. When the keyboard mode is operated, the user may input characters, etc., on the second image of the second display area DA2 using the virtual keyboard VKB displayed on the first display area DA1.

When the virtual keyboard VKB is used, the virtual keyboard VKB, which is a still image, may be displayed on the first display area DA1 for a long time, and accordingly, an afterimage due to the virtual keyboard VKB may occur. In order to prevent the afterimage due to the virtual keyboard VKB, a pixel shift such as a boundary shift in which the virtual keyboard VKB moves along an edge of the first display area DA1, an internal shift in which a part of the virtual keyboard VKB is reduced and another part of the virtual keyboard VKB is enlarged, etc. may be used. However, when the boundary shift is used, as the virtual keyboard VKB moves within the first display area DA1, the virtual keyboard VKB may be displayed asymmetrically in the first direction D1 and/or the second direction D2 within the first display area DA1. Further, when the internal shift is used, as sizes of the virtual keys VK are displayed differently, the virtual keyboard VKB may be displayed distorted.

In the display device according to some embodiments of the present disclosure, when the keyboard mode is operated, the controller 160 may generate the data signal DATA to reduce or enlarge the virtual keyboard VKB/virtual key VK with respect to a center of the virtual keyboard VKB/virtual key VK within a selected range at a selected time interval. Accordingly, the afterimage caused by the virtual keyboard VKB may decrease. Further, in the process of reducing or enlarging the virtual keyboard VKB/virtual key VK, the virtual keyboard VKB may be symmetrical in the first direction D1 and/or the second direction D2, and the sizes of the virtual keys VK may be uniform. Accordingly, display quality of the virtual keyboard VKB may be relatively improved.

According to some embodiments, the controller 160 may compensate a plurality of touch areas for the virtual keys VK in response to the reduction or enlargement of the virtual keyboard VKB/virtual key VK. When the virtual keyboard VKB/virtual key VK is reduced or enlarged, the touch areas for the virtual keys VK may be reduced or enlarged in response to the reduction or enlargement of the virtual keyboard VKB/virtual key VK. Further, when the virtual keyboard VKB is reduced or enlarged, the touch areas for the virtual keys VK may move in response to the reduction or enlargement of the virtual keyboard VKB. Accordingly, the controller 160 may generate compensation data CD for compensate the touch areas for the virtual keys VK in response to the reduction or enlargement of the virtual keyboard VKB/virtual key VK, and may provide the compensation data CD to the touch driver 150. The touch driver 150 may compensate the touch areas for the virtual keys VK based on the compensation data CD, and may accurately detect an input key value corresponding to a touch input included in the sensing data SD.

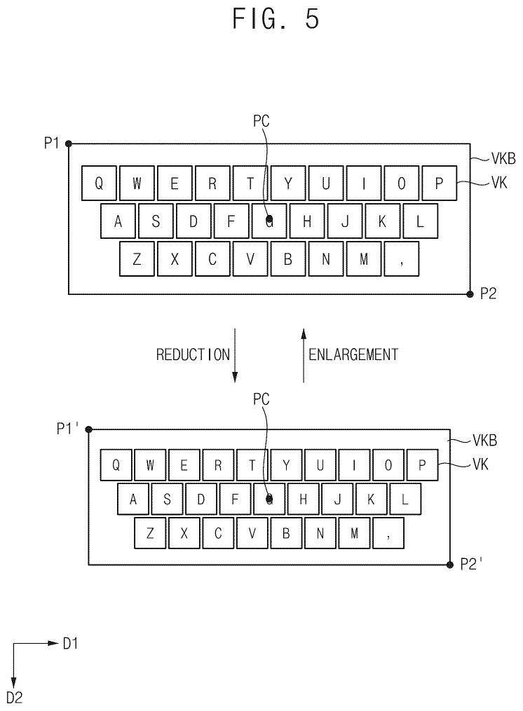

FIG. 5 is a view showing an example of reduction and enlargement of the virtual keyboard VKB.

Referring to FIG. 5, the virtual keyboard VKB may be reduced or enlarged with respect to the center of the virtual keyboard VKB within the selected range at the selected time interval. The reduction and enlargement of the virtual keyboard VKB may be periodically repeated within the selected range.

According to some embodiments, the virtual keyboard VKB may be reduced or enlarged while maintaining a length ratio of a long side of the virtual keyboard VKB to a short side of the virtual keyboard VKB. For example, the virtual keyboard VKB may have a rectangular planar shape, the short side of the virtual keyboard VKB may extend in the second direction D2, and the long side of the virtual keyboard VKB may extend in the first direction D1. For example, when the resolution of the virtual keyboard VKB is 2000×800, the virtual keyboard VKB may be reduced or enlarged while maintaining the length ratio of 2.5. As the virtual keyboard VKB is reduced or enlarged while maintaining the length ratio of the long side to the short side, the virtual keyboard VKB may be displayed without distortion in the process of reducing or enlarging the virtual keyboard VKB.

According to some embodiments, the short side of the virtual keyboard VKB may be reduced or enlarged by one pixel at the selected time interval. For example, when the resolution of the virtual keyboard VKB is 2000×800, the short side of the virtual keyboard VKB may be reduced or enlarged by one pixel at the selected time interval, and the long side of the virtual keyboard VKB may be reduced or enlarged by 2.5 pixels at the selected time interval.

According to some embodiments, the selected range in which the virtual keyboard VKB is reduced or enlarged may be from 99% to 100% (or about 99% to about 100%) of an initial size of the virtual keyboard VKB. In this case, the virtual keyboard VKB may be repeatedly reduced and enlarged within a range from 99% to 100% (or about 99% to about 100%) of the initial size of the virtual keyboard VKB. When the virtual keyboard VKB is reduced to less than 99% (or about 99%) of the initial size of the virtual keyboard VKB, the size of the virtual key VK may become too small, causing typos, and the reduction of the virtual keyboard VKB may be recognized. Further, when the virtual keyboard VKB is enlarged to greater than 100% (or about 100%) of the initial size of the virtual keyboard VKB, a portion of the virtual keyboard VKB (e.g., an edge of the virtual keyboard VKB) may not be displayed.

According to some embodiments, the selected time interval, which is a cycle in which the virtual keyboard VKB is reduced or enlarged, may be in a range from 20 seconds to 40 seconds (or from about 20 seconds to about 40 seconds). In this case, the virtual keyboard VKB may be reduced or enlarged every 20 seconds to 40 seconds (or about 20 seconds to about 40 seconds). When the virtual keyboard VKB is reduced or enlarged every time less than 20 seconds (or about 20 seconds), the user may recognize the change in the size of the virtual keyboard VKB. Further, when the virtual keyboard VKB is reduced or enlarged every time greater than 40 seconds (or about 40 seconds), an afterimage due to the virtual keyboard VKB may occur.

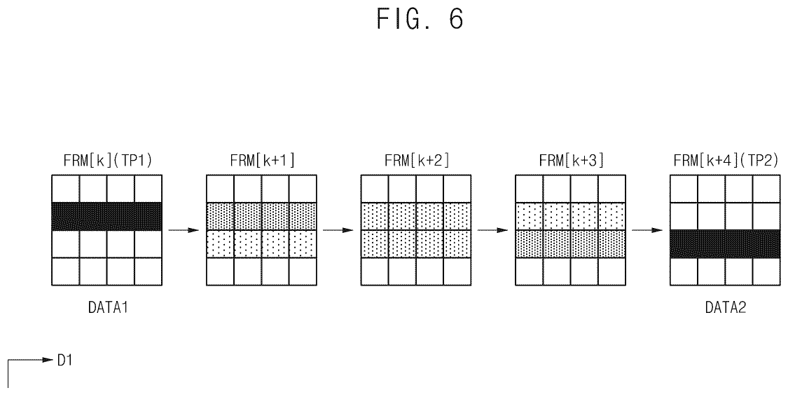

FIG. 6 is a view showing an example of micro shift of the virtual keyboard VKB.

Referring to FIGS. 3, 4, and 6, according to some embodiments, the controller 160 may generate a first data signal DATA1 to reduce or enlarge the virtual keyboard VKB with respect to the center of the virtual keyboard VKB at a first time point TP1, and may generate a second data signal DATA2 to reduce or enlarge the virtual keyboard VKB with respect to the center of the virtual keyboard VKB at a second time point TP2 after the selected time interval from the first time point TP1. The first data signal DATA1 may correspond to the virtual keyboard VKB at the first time point TP1, and the second data signal DATA2 may correspond to the virtual keyboard VKB at the second time point TP2. For example, the short side of the virtual keyboard VKB extending in the second direction D2 may be reduced or enlarged by one pixel between the first time point TP1 and the second time point TP2. In other words, the long side of the virtual keyboard VKB extending in the first direction D1 may move in the second direction D2 by one pixel between the first time point TP1 and the second time point TP2.

However, even if the virtual keyboard VKB is reduced or enlarged by one pixel, the user may recognize the reduction or enlargement of the virtual keyboard VKB as the long side of the virtual keyboard VKB moves at once. Accordingly, according to some embodiments, in order to prevent the reduction or enlargement of the virtual keyboard VKB from being recognized by the user, the controller 160 may generate a plurality of data signals by mixing the first data signal DATA1 and the second data signal DATA2 over a plurality of frames between the first time point TP1 and the second time point TP2.

During the frames between the first time point TP1 and the second time point TP2, a mixing ratio of the first data signal DATA1 may decrease, and a mixing ratio of the second data signal DATA2 may increase. According to some embodiments, during the frames between the first time point TP1 and the second time point TP2, the mixing ratio of the first data signal DATA1 may linearly decrease, and the mixing ratio of the second data signal DATA2 may linearly increase.

For example, as illustrated in FIG. 6, when the first time point TP1 is a kth frame FRM[k] and the second time point TP2 is a k+4th frame FRM[k+4], the mixing ratio of the first data signal DATA1 and the mixing ratio of the second data signal DATA2 in a k+1th frame FRM[k+1] may be 75% and 25%, respectively, the mixing ratio of the first data signal DATA1 and the mixing ratio of the second data signal DATA2 in a k+2th frame FRM[k+2] may be 50% and 50%, respectively, and the mixing ratio of the first data signal DATA1 and the mixing ratio of the second data signal DATA2 in a k+3th frame FRM[k+3] may be 25% and 75%, respectively. Accordingly, the long side of the virtual keyboard VKB extending in the first direction D1 may gradually move in the second direction D2 over the plurality of frames between the first time point TP1 and the second time point TP2, and the user may not recognize the reduction or enlargement of the virtual keyboard VKB.

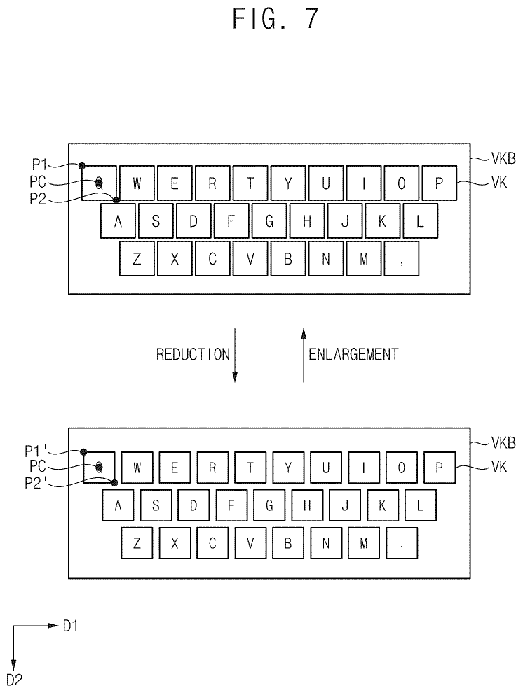

FIG. 7 is a view showing an example of reduction and enlargement of the virtual keys VK of the virtual keyboard VKB.

Referring to FIG. 7, each of the virtual keys VK may be reduced or enlarged with respect to a center of each of the virtual keys VK within a selected range at a selected time interval. The reduction and enlargement of each of the virtual keys VK may be periodically repeated within the selected range.

According to some embodiments, each of the virtual keys VK may be reduced or enlarged while maintaining a length ratio of a long side of each of the virtual keys VK to a short side of each of the virtual keys VK. For example, each of the virtual keys VK may have a square planar shape. For example, when the resolution of each of the virtual keys VK is 50×50, each of the virtual keys VK may be reduced or enlarged while maintaining the length ratio of 1. As each of the virtual keys VK is reduced or enlarged while maintaining the length ratio of the long side to the short side, the virtual keys VK may be displayed without distortion in the process of reducing or enlarging the virtual keys VK.

According to some embodiments, the short side of each of the virtual keys VK may be reduced or enlarged by one pixel at the selected time interval. For example, when the resolution of each of the virtual keys VK is 50×50, the short side of each of the virtual keys VK may be reduced or enlarged by one pixel at the selected time interval.

According to some embodiments, the selected range in which each of the virtual keys VK is reduced or enlarged may be in a range from 99% to 100% (or from about 99% to about 100%) of an initial size of each of the virtual keys VK. In this case, each of the virtual keys VK may be repeatedly reduced and enlarged within a range from 99% to 100% (or about 99% to about 100%) of the initial size of each of the virtual keys VK. When the virtual key VK is reduced to less than 99% (or about 99%) of the initial size of the virtual key VK, the size of the virtual key VK may become too small, which may cause typos, and the reduction of the virtual key VK may be recognized. Further, when the virtual key VK is enlarged to greater than 100% (or about 100%) of the initial size of the virtual key VK, the virtual keys VK may partially overlap each other.

According to some embodiments, the selected time period, which is a cycle in which each of the virtual keys VK is reduced or enlarged, may be from 20 seconds to 40 seconds (or about 20 seconds to about 40 seconds). In this case, each of the virtual keys VK may be reduced or enlarged every 20 seconds to 40 seconds (or about 20 seconds to about 40 seconds). When the virtual keys VK are reduced or enlarged every time less than 20 seconds (or about 20 seconds), the user may recognize the change in the size of the virtual keys VK. Further, when the virtual keys VK are reduced or enlarged every time greater than 40 seconds (or about 40 seconds), an afterimage may occur due to the virtual keyboard VKB.

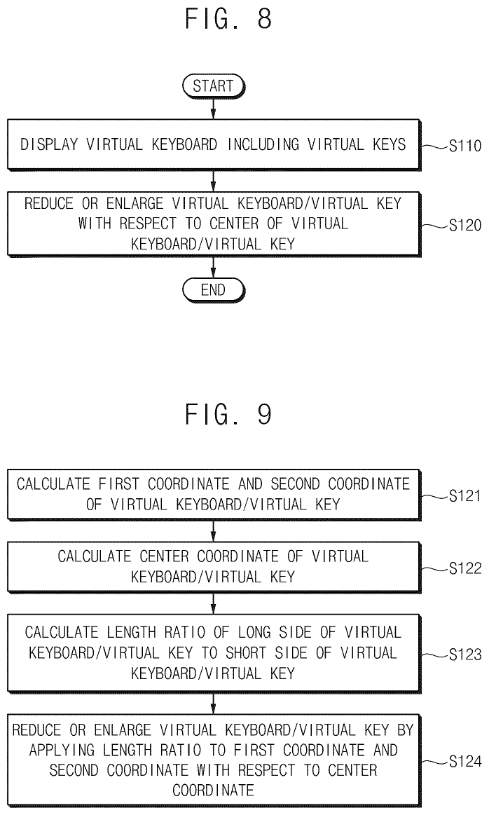

FIGS. 8 and 9 are flowcharts showing a method of driving a display device according to some embodiments.

Referring to FIGS. 4, 5, 7 to 9, a method of driving a display device may include displaying the virtual keyboard VKB including the virtual keys VK (S110), and reducing or enlarging the virtual keyboard VKB/virtual key VK with respect to the center of the virtual keyboard VKB/virtual key VK within the selected range at the selected time interval (S120). In the displaying the virtual keyboard VKB (S110), the virtual keyboard VKB may be displayed in the first display area DA1.

The reducing or enlarging the virtual keyboard VKB/virtual key VK (S120) may include calculating a first coordinate P1 and a second coordinate P2 of the virtual keyboard VKB/virtual key VK (S121), calculating a center coordinate PC of the center of the virtual keyboard VKB/virtual key VK (S122), calculating the length ratio of the long side of the virtual keyboard VKB/virtual key VK to the short side of the virtual keyboard VKB/virtual key VK (S123), and reducing or enlarging the virtual keyboard VKB/virtual key VK by applying the length ratio to the first coordinate P1 and the second coordinate P2 with respect to the center coordinate PC (S124).

In the calculating the first coordinate P1 and the second coordinate P2 of the virtual keyboard VKB/virtual key VK (S121), as illustrated in FIGS. 5 and 7, an upper left corner of the virtual keyboard VKB/virtual key VK may be calculated as the first coordinate P1, and a lower right corner of the virtual keyboard VKB/virtual key VK may be calculated as the second coordinate P2. With respect to an X-axis extending in the first direction D1 and a Y-axis extending in the second direction D2, the first coordinate P1 may be expressed as P1(X1, Y1), and the second coordinate P2 may be expressed as P2(X2, Y2). The first coordinate P1 may represent a coordinate of a pixel located at the upper left corner of the virtual keyboard VKB/virtual key VK among the pixels included in the display panel 110, and the second coordinate P2 may represent a coordinate of a pixel located at the lower right corner of the virtual keyboard VKB/virtual key VK among the pixels included in the display panel 110.

In the calculating the center coordinate PC of the center of the virtual keyboard VKB/virtual key VK (S122), as illustrated in FIGS. 5 and 7, the center coordinate PC of the center of the virtual keyboard VKB/virtual key VK may be calculated based on the first coordinate P1 and the second coordinate P2. The center coordinate PC may represent a coordinate of a pixel located at the center of the virtual keyboard VKB/virtual key VK among the pixels included in the display panel 110. The center coordinate PC may be calculated by mathematical equation 1.

PC=(P1+P2)/2 Mathematical equation 1

In the calculating the length ratio of the long side of the virtual keyboard VKB/virtual key VK to the short side of the virtual keyboard VKB/virtual key VK (S123), the length ratio R_XY of the long side of the virtual keyboard VKB/virtual key VK to the short side of the virtual keyboard VKB/virtual key VK may be calculated based on the first coordinate P1 and the second coordinate P2. As illustrated in FIG. 5, when the long side of the virtual keyboard VKB extends in the first direction D1 and the short side of the virtual keyboard VKB extends in the second direction D2, the length ratio R_XY may be calculated by mathematical equation 2.

R_XY=(X2−X1)/(Y2−Y1) Mathematical equation 2

In the reducing or enlarging the virtual keyboard VKB/virtual key VK by applying the length ratio to the first coordinate P1 and the second coordinate P2 with respect to the center coordinate PC (S124), the first coordinate P1′ and the second coordinate P2′ may be changed by applying the length ratio R_XY to the first coordinate P1 and the second coordinate P2 at the selected time interval. The changed first coordinate P1′ may be an upper left corner of the reduced or enlarged virtual keyboard VKB/virtual key VK, and the changed second coordinate P2′ may be a lower right corner of the reduced or enlarged virtual keyboard VKB/virtual key VK. For example, when the short side of the virtual keyboard VKB/virtual key VK is reduced by one pixel every selected n seconds (n is a natural number greater than or equal to 1), the changed first coordinate P1′ may be expressed as P1′(X1+n*R_XY, Y1+n), and the changed second coordinate P2′ may be expressed as P2′(X2−n*R_XY, Y2−n). As the virtual keyboard VKB/virtual key VK is reduced or enlarged with respect to the center coordinate PC, the center coordinate PC may not be changed even if the virtual keyboard VKB/virtual key VK is reduced or enlarged.

The virtual keyboard VKB/virtual key VK may be reduced or enlarged with respect to the center of the virtual keyboard VKB/virtual key VK within the selected range at the selected time interval. The reduction and enlargement of the virtual keyboard VKB/virtual key VK may be periodically repeated within the selected range.

According to some embodiments, the virtual keyboard VKB/virtual key VK may be reduced or enlarged while maintaining the length ratio of the long side of the virtual keyboard VKB/virtual key VK to the short side of the virtual keyboard VKB/virtual key VK. As the virtual keyboard VKB/virtual key VK is reduced or enlarged while maintaining the length ratio of the long side to the short side, the virtual keyboard VKB/virtual key VK may be displayed without distortion in the process of reducing or enlarging the virtual keyboard VKB/virtual key VK.

According to some embodiments, the short side of the virtual keyboard VKB/virtual key VK may be reduced or enlarged by one pixel at the selected time interval. According to some embodiments, the selected range in which the virtual keyboard VKB/virtual key VK is reduced or enlarged may be in a range from 99% to 100% (or from about 99% to about 100%) of the initial size of the virtual keyboard VKB/virtual key VK. In this case, the virtual keyboard VKB/virtual key VK may be repeatedly reduced and enlarged within the range from 99% to 100% (or about 99% to about 100%) of the initial size of the virtual keyboard VKB/virtual key VK.

According to some embodiments, the selected time interval, which is the cycle in which the virtual keyboard VKB/virtual key VK is reduced or enlarged, may be from 20 seconds to 40 seconds (or about 20 seconds to about 40 seconds). In this case, the virtual keyboard VKB/virtual key VK may be reduced or enlarged every 20 seconds to 40 seconds (or about 20 seconds to about 40 seconds).

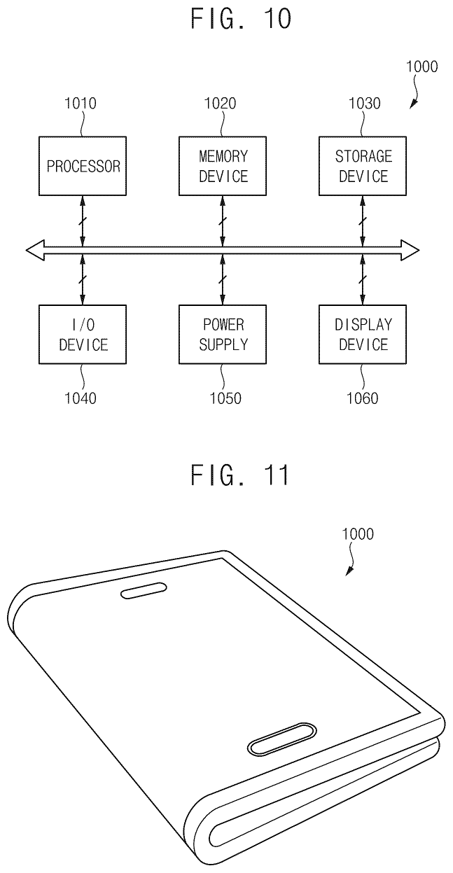

FIG. 10 is a block diagram showing an electronic apparatus 1000 according to some embodiments. FIG. 11 is a view showing an example in which the electronic apparatus 1000 of FIG. 10 is implemented as a foldable computer.

Referring to FIGS. 10 and 11, an electronic apparatus 1000 may include a processor 1010, a memory device 1020, a storage device 1030, an input/output (I/O) device 1040, a power supply 1050, and a display device 1060. The electronic apparatus 1000 may further include a plurality of ports capable of communicating with a video card, a sound card, a memory card, a USB device, and the like, or communicating with other systems.

According to some embodiments, as illustrated in FIG. 11, the electronic apparatus 1000 may be implemented as a foldable computer. However, embodiments according to the present disclosure are not limited thereto, and according to some embodiments, the electronic apparatus 1000 may be implemented as a television, a mobile phone, a video phone, a smart pad, a smart watch, a vehicle navigation system, a notebook, a head-mounted display, etc.

The processor 1010 may perform specific calculations or tasks. According to some embodiments, the processor 1010 may be a microprocessor, a central processing unit (CPU), or the like. The processor 1010 may be connected to other components through an address bus, a control bus, a data bus, and the like. According to some embodiments, the processor 1010 may also be connected to an expansion bus such as a peripheral component interconnect (PCI) bus. The processor 1010 may control the display device 1060. According to some embodiments, the processor 1010 may provide the input image data IMG of FIG. 3 and the input control signal CONT of FIG. 3 to the display device 1060.

The memory device 1020 may store data required for an operation of the electronic apparatus 1000. For example, the memory device 1020 may include: a nonvolatile memory device such as an erasable programmable read-only memory (EPROM), an electrically erasable programmable read-only memory (EEPROM), a flash memory, a phase change random access memory (PRAM), a resistance random access memory (RRAM), a nano floating gate memory (NFGM), a polymer random access memory (PoRAM), a magnetic random access memory (MRAM), or a ferroelectric random access memory (FRAM); and/or a volatile memory device such as a dynamic random access memory (DRAM), a static random access memory (SRAM), or a mobile DRAM.

The storage device 1030 may include a solid state drive (SSD), a hard disk drive (HDD), a CD-ROM, and the like. The I/O device 1040 may include: an input device such as a keyboard, a keypad, a touch pad, a touch screen, or a mouse; and an output device such as a speaker or a printer. The power supply 1050 may supply a power required for the operation of the electronic apparatus 1000. The display device 1060 may display an image. The display device 1060 may be connected to other components through the buses or other communication links. The display device 1060 may correspond to the display device 100 of FIGS. 1 to 3.

In the display device 1060, a virtual keyboard/virtual key is reduced or enlarged with respect to a center of the virtual keyboard/virtual key within a selected range at a selected time interval, so that an afterimage caused by the virtual keyboard may decrease. Further, in the process of reducing or enlarging the virtual keyboard, the virtual keyboard is symmetric and sizes of the virtual keys are uniform, so that display quality of the virtual keyboard may be relatively improved.

The display device according to the embodiments may be applied to a display device included in a computer, a notebook, a mobile phone, a smart phone, a smart pad, a smart watch, a PMP, a PDA, an MP3 player, or the like.

Although the gate driver, the display device, and the electronic apparatus according to the embodiments have been described with reference to the drawings, the shown embodiments are examples, and may be modified and changed by a person having ordinary knowledge in the relevant technical field without departing from the technical spirit and scope of embodiments according to the present disclosure as described in the following claims, and their equivalents.

What is claimed is:

1. A display device comprising:
a display panel including a first display area configured to display a virtual keyboard including a plurality of virtual keys and a second display area adjacent to the first display area;
a data driver configured to provide a data voltage to the display panel; and
a controller configured to provide a data signal to the data driver,
wherein the controller configured to generate the data signal to reduce or enlarge the virtual keyboard with respect to a center of the virtual keyboard within a selected range at a selected time interval.

2. The display device of claim 1, wherein the virtual keyboard is configured to be reduced or enlarged while maintaining a length ratio of a long side of the virtual keyboard to a short side of the virtual keyboard.

3. The display device of claim 2, wherein the short side of the virtual keyboard is configured to be reduced or enlarged by one pixel at the selected time interval.

4. The display device of claim 1, wherein the selected range is from 99% to 100% of an initial size of the virtual keyboard.

5. The display device of claim 1, wherein the selected time interval is in a range from 20 seconds to 40 seconds.

6. The display device of claim 1, wherein a first data signal corresponds to the virtual keyboard at a first time point and a second data signal corresponds to the virtual keyboard at a second time point after the selected time interval from the first time point, and
wherein the controller is configured to generate a plurality of data signals by mixing the first data signal and the second data signal over a plurality of frames between the first time point and the second time point.

7. The display device of claim 6, wherein a mixing ratio of the first data signal decreases and a mixing ratio of the second data signal increases during the plurality of frames.

8. The display device of claim 1, wherein the controller is configured to compensate a plurality of touch areas for the plurality of virtual keys in response to reduction or enlargement of the virtual keyboard.

9. The display device of claim 1, wherein the display panel is foldable along a folding line,
wherein the first display area is located on a first side of the folding line, and
wherein the second display area is located on a second side of the folding line.

10. A display device comprising:
a display panel including a first display area configured to display a virtual keyboard including a plurality of virtual keys and a second display area adjacent to the first display area;
a data driver configured to provide a data voltage to the display panel; and
a controller configured to provide a data signal to the data driver,
wherein the controller is configured to generate the data signal to reduce or enlarge each of the plurality of virtual keys with respect to a center of each of the plurality of virtual keys within a selected range at a selected time interval.

11. The display device of claim 10, wherein each of the plurality of virtual keys is configured to be reduced or enlarged while maintaining a length ratio of a long side of each of the plurality of virtual keys to a short side of each of the plurality of virtual keys.

12. The display device of claim 11, wherein the short side of each of the plurality of virtual keys is configured to be reduced or enlarged by one pixel at the selected time interval.

13. The display device of claim 10, wherein the selected range is from 99% to 100% of an initial size of each of the plurality of virtual keys.

14. The display device of claim 10, wherein the selected time interval is in a range from 20 seconds to 40 seconds.

15. The display device of claim 10, wherein a first data signal corresponds to the virtual keyboard at a first time point and a second data signal corresponds to the virtual keyboard at a second time point after the selected time interval from the first time point, and
wherein the controller is configured to generate a plurality of data signals by mixing the first data signal and the second data signal over a plurality of frames between the first time point and the second time point.

16. The display device of claim 15, wherein a mixing ratio of the first data signal decreases and a mixing ratio of the second data signal increases during the plurality of frames.

17. An electronic apparatus comprising a display device configured to display an image and a processor configured to provide input image data to the display device, the display device comprising:
a display panel including a first display area configured to display a virtual keyboard including a plurality of virtual keys and a second display area adjacent to the first display area;
a data driver configured to provide a data voltage to the display panel; and
a controller configured to generate a data signal based on the input image data and to provide the data signal to the data driver,
wherein the controller configured to generate the data signal to reduce or enlarge the virtual keyboard with respect to a center of the virtual keyboard within a selected range at a selected time interval.

18. The electronic apparatus of claim 17, wherein the virtual keyboard is configured to be reduced or enlarged while maintaining a length ratio of a long side of the virtual keyboard to a short side of the virtual keyboard.

19. The electronic apparatus of claim 18, wherein the short side of the virtual keyboard is configured to be reduced or enlarged by one pixel at the selected time interval.

20. The electronic apparatus of claim 17, wherein the selected range is from 99% to 100% of an initial size of the virtual keyboard.
